(19) United States
(12) Patent Application Publication
(10) Pub. No.: US 2003/0065597 A1
(43) Pub. Date: Apr. 3, 2003

(54) Creating and distributing a software application

(76) Inventors: Steven B. Smith, Holladay, UT (US); Richard T. Kuhn, Holladay, UT (US); Brent Evans, Holladay, UT (US); David Neddo, Midvale, UT (US); Dennis Higbee, Riverton, UT (US)

Correspondence Address: KIRTON AND MCCONKIE, 1800 EAGLE GATE TOWER, 60 EAST SOUTH TEMPLE, P O BOX 45120, SALT LAKE CITY, UT, 84145-0120, US

(21) Appl. No.: 09/968,307

(22) Filed: Oct. 1, 2001

(51) Int. Cl. G06F 17/60

(52) U.S. Cl. 705/36; 705/35

(57) ABSTRACT

Systems and methods for creating and distributing a software application that includes one or more categories that sweep information to one or more products provided by a professional at the end of a predefined period of time. The professional is engaged to distribute the software application to current and potential customers. Upon identifying a customer, the professional introduces the software application to the customer. Because the professional is familiar with the software application, he/she is able to provide a personal endorsement of the program to the customer. If the customer purchases the software application, the professional provides ongoing follow-up and support to the customer. As such, implementation of the present invention allows for the distribution of a software application using a channel that is closer to the customer and that provides added credibility to the program.

### BACKGROUND OF THE INVENTION

1. Field of the Invention

The present invention relates to systems and methods for creating and distributing a software application. More particular, the present invention relates to creating a software application that includes a category for sweeping or transferring information, such as financial information, to one or more products provided by a particular professional, and utilizing the professional to distribute the software application to end users.

2. Background and Related Art

With the advent of computer devices, such as a personal computer or a personal digital assistant (“PDA”), software applications have been developed that may be loaded onto or otherwise used by a computer device. Traditional channels for distributing such software applications to customers include retail channels, as will be discussed below.

Retail channels used to distribute software applications to customers include preloading a software application onto a computer device sold in the retail industry and making the software application available for sale through retail stores, catalogues, or web pages. When computer devices are placed on sale software applications are often preloaded and the devices are sold through a retail store, catalogue or web page. Thus, for example, when a new personal computer, such as a laptop, is available for purchase by a customer, the laptop includes software applications thereon, such as a word processing program, a spreadsheet application, and/or an internet browser that are distributed to the purchaser upon procurement of the laptop.

A software application may also be independently available for distribution through a retail store. The software application is made available for purchase by preserving a copy of the application onto one or more floppy or compact disks that are packaged and placed on sale. At a retail store, a customer may enter and browse the available titles of various similar software applications in order to determine which application will be purchased and loaded onto the customer's computer.

Similarly, catalogues are used to distribute a software application to customers. A catalogue may be obtained or otherwise received by a customer that indicates the various software applications available for purchase. Upon examining the various representations or advertisements for the various software applications, the customer may select one for purchase.

Likewise, a software application may be distributed through the use of a web page. A customer may access a web page on the internet that identifies one or more software applications available for sale. The customer determines from the available applications the application that he/she will purchase. The order is placed and the application is either delivered on floppy or compact disks or is downloaded to the customer across the internet.

While retail channels distribute a software application to customers, retail channels do not typically signify the quality of the application or the appropriateness of the application in attending to the needs of the customer, only the availability thereof amidst other software applications within the same category. Furthermore, a stocking relationship is required with each of the retail entities, which can be time consuming and expensive. Moreover, once an application is purchased or obtained the application is often unsupported by the channel in which it was distributed.

### SUMMARY OF THE INVENTION

The present invention relates to systems and methods for creating and distributing a software application. More particular, the present invention relates to creating a software application that includes a category for sweeping or transferring information, such as financial information, to one or more products provided by a particular professional, and utilizing the professional to distribute the software application to end users.

Implementation of the present invention takes place in association with a professional that is engaged to market a particular software application with pre-established or potential customers. The professional provides products to an established customer pool and is engaged by a software developer or company to market a particular software application that is related to the products provided.

In one implementation the software application is a financial management tool and the professional engaged to market the application is an insurance agent, a certified financial planner, a bank or credit union, a tax preparer, a stock broker, or a certified public accountant. The software application is configured to allow for the management of finances, recognize the amount of unused funds upon the completion of a period of time, and sweep at least a portion of the unused funds to a product or account managed or offered by the professional.

When the professional is a stockbroker that manages a variety of investment funds, the financial management tool is configured to identify and apportion unused funds at the end of a financial period that are available for deposit into one or more of the funds managed by the stockbroker. The software developer or company engages the stockbroker to market the software application to his/her current or potential customers. Upon identifying a customer, the stockbroker explains that the software application will assist the customer in managing finances and in incrementally investing in various funds. The stockbroker, having become familiar with the software application, is able to provide a personal endorsement of the program. If the customer chooses not to purchase the application, another customer is identified for introduction to the application. Alternatively, if the customer elects to purchase the software application, the stockbroker may provide follow-up and support to the customer in addition to support that may be provided by the software company. Another customer is identified and introduced to the application.

Therefore, implementation of the present invention allows for the distribution of a software application using a channel that is closer to the customer and provides added credibility to the product. This channel for distributing software assists the customer by obtaining an application that is beneficial to the customer and endorsed by one with whom the customer already has confidence. This channel also assists the stockbroker by resulting in ongoing contact with established customers.

While the methods and processes of the present invention have proven to be particularly useful in the area of distributing financial management software, those skilled in the art can appreciate that the methods and processes can be used in a variety of different areas of manufacture to distribute a product to a customer in a manner that is closer to the customer and that provides credibility to the product.

These and other features and advantages of the present invention will be set forth or will become more fully apparent in the description that follows and in the appended claims. The features and advantages may be realized and obtained by means of the instruments and combinations particularly pointed out in the appended claims. Furthermore, the features and advantages of the invention may be learned by the practice of the invention or will be obvious from the description, as set forth hereinafter.

### BRIEF DESCRIPTION OF THE DRAWINGS

In order that the manner in which the above recited and other features and advantages of the present invention are obtained, a more particular description of the invention will be rendered by reference to specific embodiments thereof, which are illustrated in the appended drawings. Understanding that the drawings depict only typical embodiments of the present invention and are not, therefore, to be considered as limiting the scope of the invention, the present invention will be described and explained with additional specificity and detail through the use of the accompanying drawings in which:

FIG. 1 illustrates a representative system that provides a suitable operating environment for use in association with a representative software application;

FIG. 2 illustrates a flow chart that provides a representative method performed by a software application that may be used in association with the system of FIG. 1; and

FIG. 3 illustrates a flow chart that provides a representative method for distributing the software application of FIG. 2 to end-users.

### DETAILED DESCRIPTION OF THE INVENTION

The present invention relates to systems and methods for creating and distributing a software application. More particular, the present invention relates to creating a software application that includes the ability to transfer information, such as financial information, to one or more products provided by a particular professional, and utilizing the professional to distribute the software application to end users.

Embodiments of the present invention take place in association with a professional that provides products to an established customer pool. In the disclosure and in the claims, the term “product” or “products” shall refer to one or more goods, services, accounts, funds, policies, and/or plans. The professional is engaged by a software developer or company to market a particular software application, which is related to the products provided, to established or potential customers of the professional, as will be further explained below.

In accordance with the present invention, tasks performed by a particular computer device responsive to instructions issued from a software application are related to the channels used to distribute the software application to the end user. As such, the following includes a disclosure relating to an exemplary computer device, an exemplary software application, and an exemplary distribution channel. Therefore, for convenience of the reader only, the following disclosure of the present invention is grouped into three subheadings, namely “Exemplary System Configuration,” “Exemplary Software Application” and “Distribution of the Software Application.” As the utilization of the subheadings is for convenience only, it is not to be construed as limiting in any sense.

### Exemplary System Configuration

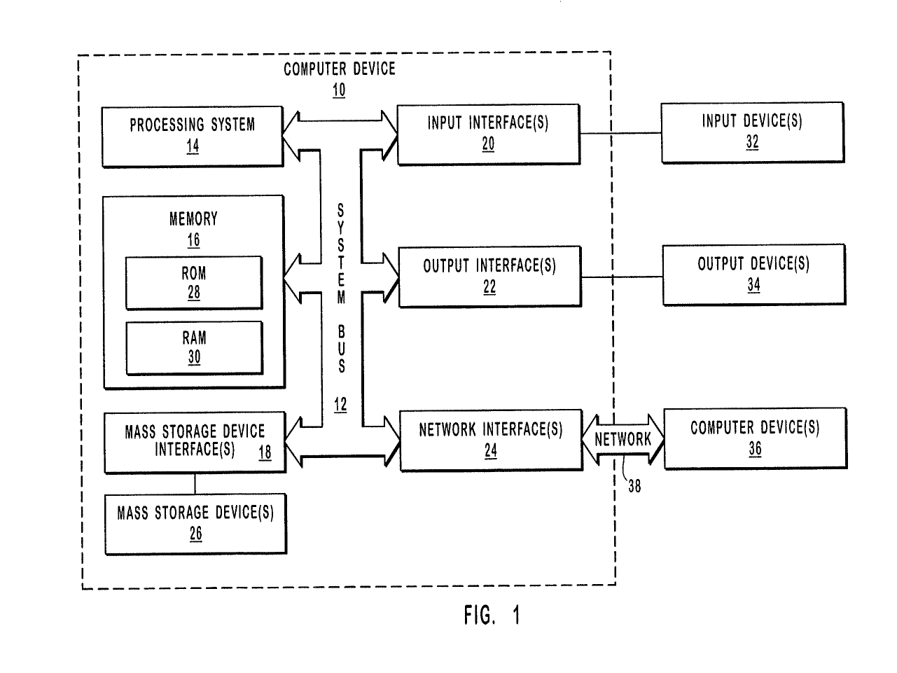

The present invention relates to creating a software application for use on a computer device, wherein the software application includes the ability to sweep an amount of income toward a particular financial product. Therefore, FIG. 1 and the corresponding discussion are intended to provide a general description of a suitable operating environment for the software application. While the operating environment is illustrated in FIG. 1 as computer device 10, one skilled in the art will appreciate that the invention may be practiced in a variety of system configurations, including in a networked configuration, as will be further explained below.

As software applications include computer executable instructions that are preserved on computer readable media and/or that utilize the media in the performance of a particular task, embodiments of the present invention embrace one or more computer readable media, wherein each medium may be configured to include or includes thereon data or computer executable instructions for manipulating data. The computer executable instructions include data structures, objects, programs, routines, or other program modules that may be accessed by a processing system, such as one associated with a general-purpose computer capable of performing various different functions or one associated with a special-purpose computer capable of performing a limited number of functions. Computer executable instructions cause the processing system to perform a particular function or group of functions and are examples of program code means for implementing steps for methods disclosed herein. Furthermore, a particular sequence of the executable instructions provides an example of corresponding acts that may be used to implement such steps. Examples of computer readable media include random-access memory (“RAM”), read-only memory (“ROM”), programmable read-only memory (“PROM”), erasable programmable read-only memory (“EPROM”), electrically erasable programmable read-only memory (“EEPROM”), compact disk read-only memory (“CD-ROM”), or any other device or component that is capable of providing data or executable instructions that may be accessed by a processing system.

With reference to FIG. 1, a representative system for implementing a software application, which includes the ability to sweep an amount of income or revenue toward a particular financial product, includes computer device 10, which may be a general-purpose or special-purpose computer. For example, computer device 10 may be a personal computer, a notebook computer, a personal digital assistant (“PDA”) or other hand-held device, a workstation, a minicomputer, a mainframe, a supercomputer, a multi-processor system, a network computer, a processor-based consumer electronic device, or the like.

Computer device 10 includes system bus 12, which may be configured to connect various components thereof and enables data to be exchanged between two or more components. System bus 12 may include one of a variety of bus structures including a memory bus or memory controller, a peripheral bus, or a local bus that uses any of a variety of bus architectures. Typical components connected by system bus 12 include processing system 14 and memory 16. Other components may include one or more mass storage device interfaces 18, input interfaces 20, output interfaces 22, and/or network interfaces 24, each of which will be discussed below.

Processing system 14 includes one or more processors, such as a central processor and optionally one or more other processors designed to perform a particular function or task. It is typically processing system 14 that executes the instructions provided on computer readable media, such as on memory 16, a magnetic hard disk, a removable magnetic disk, a magnetic cassette, an optical disk, or from a communication connection, which may also be viewed as a computer readable medium.

Memory 16 includes one or more computer readable media that may be configured to include or includes thereon data or instructions for manipulating data, and may be accessed by processing system 14 through system bus 12. Memory 16 may include, for example, ROM 28, used to permanently store information, and/or RAM 30, used to temporarily store information. ROM 28 may include a basic input/output system (“BIOS”) having one or more routines that are used to establish communication, such as during start-up of computer device 10. RAM 30 may include one or more program modules, such as an operating system, program data, and/or an application program, such as one that includes a category for sweeping an amount of revenue toward a particular product or account.

One or more mass storage device interfaces 18 may be used to connect one or more mass storage devices 26 to system bus 12. The mass storage devices 26 may be incorporated into or may be peripheral to computer device 10 and allow computer device 10 to retain large amounts of data. Optionally, one or more of the mass storage devices 26 may be removable from computer device 10. Examples of mass storage devices include hard disk drives, magnetic disk drives, tape drives and optical disk drives. A mass storage device 26 may read from and/or write to a magnetic hard disk, a removable magnetic disk, a magnetic cassette, an optical disk, or another computer readable medium. Mass storage devices 26 and their corresponding computer readable media provide nonvolatile storage of data and/or executable instructions that may include one or more program modules such as an operating system, one or more application programs, other program modules, or program data. Such executable instructions are examples of program code means for implementing steps for methods disclosed herein.

One or more input interfaces 20 may be employed to enable a user to enter data and/or instructions to computer device 10 through one or more corresponding input devices 32. Examples of such input devices include a keyboard and alternate input devices, such as a mouse, trackball, light pen, stylus, or other pointing device, a microphone, a joystick, a game pad, a satellite dish, a scanner, a camcorder, a digital camera, and the like. Similarly, examples of input interfaces 20 that may be used to connect the input devices 32 to the system bus 12 include a serial port, a parallel port, a game port, a universal serial bus (“USB”), a firewire (IEEE 1394), or another interface.

One or more output interfaces 22 may be employed to connect one or more corresponding output devices 34 to system bus 12. Examples of output devices include a monitor or display screen, a speaker, a printer, and the like. A particular output device 34 may be integrated with or peripheral to computer device 10. Examples of output interfaces include a video adapter, an audio adapter, a parallel port, and the like.

One or more network interfaces 24 enable computer device 10 to exchange information with one or more other local or remote computer devices, illustrated as computer devices 36, via a network 38 that may include hardwired and/or wireless links. Examples of network interfaces include a network adapter for connection to a local area network (“LAN”) or a modem, wireless link, or other adapter for connection to a wide area network (“WAN”), such as the Internet. The network interface 24 may be incorporated with or peripheral to computer device 10. In a networked system, accessible program modules or portions thereof may be stored in a remote memory storage device. Furthermore, in a networked system computer device 10 may participate in a distributed computing environment, where functions or tasks are performed by a plurality of networked computer devices.

The disclosure above has provided a discussion relating to a representative computer device that may be used to implement a software application that includes a category for sweeping information, such as an amount of income, toward a particular financial product. Those skilled in the art will appreciate that the present invention may be practiced in association with a variety of different types of computer system configurations, including networked computing environments, to implement the computer executable instructions provided in the software application program in order to selectively sweep information toward one or more products.

### Exemplary Software Application

A software application includes computer readable instructions that may be used in association with a computer device or system, such as computer device 10 of FIG. 1, for performing a particular task or group of tasks. The computer readable instructions are preserved in a computer readable medium, such as RAM 30 of FIG. 1, and are accessible by one or more processors, such as processing system 14 of FIG. 1, in order to perform the tasks or group of tasks.

In one embodiment of the present invention, the software application includes one or more categories of data or information that may be selectively swept or transferred. The information swept by the software application may be any type of data or information that may be tracked. For example, the software application may be a financial management tool that tracks assets or revenues of one or more individuals or entities. The tool keeps a record of all earnings and expenditures and determines the amount of unused earnings upon the completion of a particular period of time. The tool further includes one or more categories that represent one or more products, such as one or more finds, accounts, policies, or investments used by the individual or entity. The unused earnings may then be selectively swept or transferred so as to be apportioned into the one or more products according to preset criteria.

In one embodiment, the information is transferred electronically by the software application. Therefore, the software application identifies an amount that may be transferred to a particular product at the end of a period and initiates the electronic transfer. In another embodiment, the transferring of information comprises identifying to the user an amount that may be transferred to a particular product at the end of a period of time so as to allow the user to selectively perform or otherwise initiate the transfer.

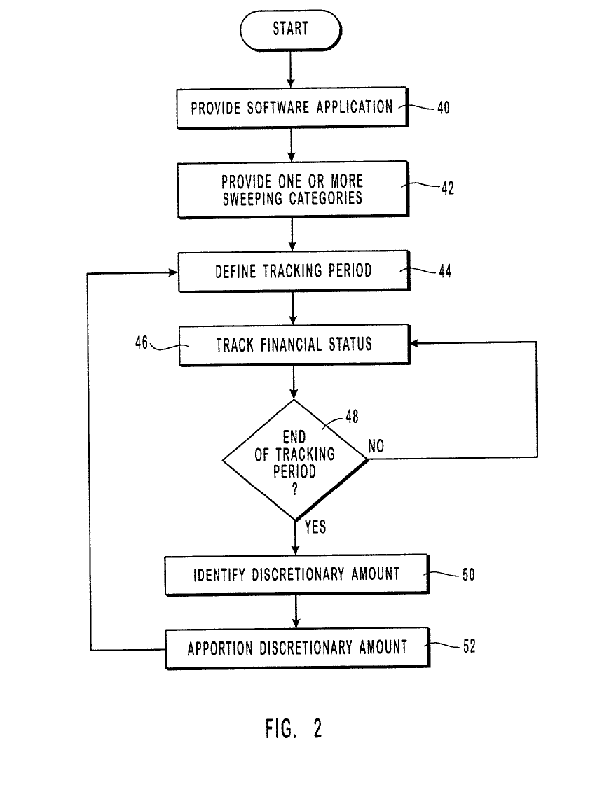

With reference to FIG. 2, a representative method is illustrated. In FIG. 2, execution begins at step 40, where a software application is provided. As provided above, the software application is configured to include or accept one or more categories of data or information that may be electronically swept or transferred. The data or information may include personal information, business information, or any other information that is capable of being tracked. Furthermore, the software application may be used in association with one or more of a variety of computer devices, including a personal computer or a PDA. In one embodiment, the software application provided at step 40 is a financial management tool that may be configured for use in association with a computer device. Execution then proceeds to step 42.

At step 42, one or more categories are created or defined in the software application provided in step 40. The categories are sweeping categories such that they are configured to initiate the transfer of information upon the completion of a period of time based on predetermined criteria. The initiation may include identifying to a user an amount to transfer to a product so that the user may selectively perform the transfer, or may include instigating the electronic transfer on behalf of the user. Thus, when the software application is a financial management tool, the categories created or otherwise defined at step 42 allocate an amount of assets to one or more products at the close of a predetermined time period. The categories may be preset by the developer of the software or alternatively may be selectively defined and/or modified by the user of the computer device. Execution then proceeds to step 44.

At step 44 the tracking period is defined. A tracking period may be any period of time in which it is advantageous for the software application to track the data or information. For example, the tracking period of a financial management tool may be from week to week, from paycheck to paycheck, from month to month, from year to year, or for any other period of time. Furthermore, the tracking period may be defined by the software developer or alternatively may be selectively defined by the user of the computer device. Execution then proceeds to step 46.

At step 46, where the software application is a financial management tool, the financial status of an individual, entity or organization is tracked by the software application that was provided in step 40. The financial status may include the earnings and expenditures of the individual, entity or organization. Furthermore, the financial status is tracked for the period of time defined at step 44. Thus, at decision block 48 a determination is made as to whether or not the tracking period defined at step 44 has ended. If it is determined that the tracking period has not ended, execution then returns back to step 46 in order for the software application to continue tracking the financial status of the individual, entity or organization. This process of tracking proceeds until decision block 48 determines that the tracking period, as defined at step 44, has ended. Execution then proceeds to step 50.

Once the tracking period has ended, the sweeping categories provided at step 42 are utilized at steps 50 and 52. For example, when the software application is a financial management tool that has tracked the financial status of an individual, entity or organization a discretionary amount is identified at step 50. The discretionary amount is, for example, at least a portion of the difference between the earnings and the expenditures of the individual, entity or organization. Furthermore, the discretionary amount may be zero, such as when the difference is low or negative.

The discretionary amount is identified at step 50 so as to be apportioned according the sweeping categories provided at step 42. The apportionment of the discretionary amount is performed automatically or selectively at step 52. When the application is a financial management tool, the apportionment includes instigating the transfer of or otherwise depositing the discretionary amount identified at step 50 into one or more products. Execution then returns back to step 44, where a subsequent tracking period is defined and the status is tracked at step 48, the discretionary amount is identified at step 50 at the end of that period, and an apportionment is made at step 52.

Thus, in accordance with the present invention a software application is developed that includes one or more categories of data or information that may be electronically swept or transferred to an advantageous location. The information swept by the software application may be any type of data or information that may be tracked by a computer device, including business, personal, and/or financial data. The location is advantageous to the user, such as an investment fund, account or product in order to help the user provide incremental investments when the data tracked is personal financial information.

### Distributing the Software Application

The tasks performed by a particular computer device responsive to instructions issued from a software application are related to the channels used to distribute the software application to an end user in accordance with the present invention. The software application is configured to accept or include categories that sweep or transfer information at the end of a particular period of time. The categories correspond to one or more products that are provided by a professional. The software developer or company engages the professional to market the software application to his/her pre-established or potential customers. Therefore, the professional is used as a channel to distribute a software application that includes categories that correspond to the products provided by the professional.

In one embodiment, the software application is a financial management tool and the professional engaged to market the application is an insurance agent, a certified financial planner, a bank or credit union representative, a tax preparer, a stock broker, a certified public accountant, or another financial assistant. The software application is designed to manage finances, recognize the amount of unused funds at the end of a period of time, and sweep at least a portion of the unused funds to a product managed, provided, or otherwise offered by the professional. Thus, for example, when the professional is a stockbroker that manages a variety of investment funds, the financial management tool may be configured to identify and apportion unused funds at the end of a financial period that are available for deposit into one or more of the funds managed by the stockbroker. The software developer or company engages the professional to market the software application to current or potential customers of the stockbroker, as will be further explained below.

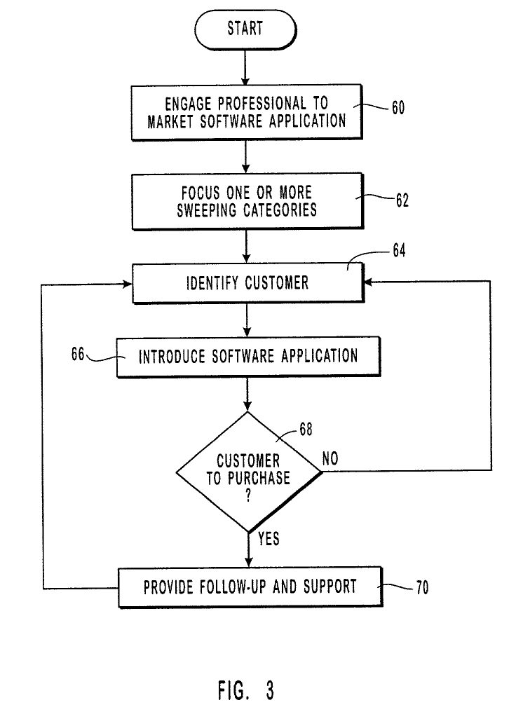

With reference to FIG. 3, a representative embodiment is illustrated that provides a method for distributing a software application having one or more sweeping categories to an end user by engaging a professional that represents products that correspond to the categories of the software application. In FIG. 3, execution begins at step 60, where a professional is engaged to market a software application having one or more categories that sweep or transfer information, such as financial information. The professional engaged at step 60 represents one or more products to an established customer pool and the categories of the software application sweep the information into one or more of the products provided by the professional. As such, the software developer or company recruits professionals to distribute the software application and certifies the professional as an agent. Execution then proceeds to step 62.

At step 62, one or more of the categories of the software application are focused so as to correspond to one or more of the products and/or services provided by the professional engaged at step 60. Therefore, for example, when the professional is a stockbroker that represents various funds, accounts or other investment opportunities, the software application is focused or adapted to include categories that sweep an amount of financial assets to one or more of the funds, assets, or investment opportunities represented by the stockbroker. Furthermore, the professional is supplied with one or more copies of the software application in order to market the application to current and future customers. Execution then proceeds to step 64.

At step 64, the professional engaged at step 60 identifies a particular customer. The customer may be, for example, a potential customer or a current customer of the professional. At step 66 the professional introduces the customer identified at step 64 to the software application. For example, a stock broker may inform the customer that the software application will assist the customer in managing the customer's finances and in incrementally investing discretionary assets toward one or more funds, accounts or investment opportunities provided by the professional. Such an approach is advantageous because a relationship of trust has previously been kindled between the stockbroker and the customer due to past business dealings. Execution then proceeds to decision block 68.

At decision block 68, a determination is made as to whether or not the customer will purchase the software application. In one embodiment, if the customer purchases the software application, the professional receives a commission on the sale of the software application and/or ensuing service fees. If it is determined that the customer is not to purchase the software application, execution returns back to step 64 for the identification of a subsequent customer by the professional engaged at step 60. Once the subsequent customer is identified at step 60, he/she is introduced to the software application at step 66 and at decision block 68 a determination is made as to whether or not the subsequent customer will purchase the software application.

Once it is determined at decision block 68 that a customer will purchase the software application, the professional provides follow-up and support to the customer at step 70 in addition to the support that may be offered by the software company. The follow-up and support by the professional provides additional interaction between the professional and the customer, thereby providing continued opportunities to discuss, for example, personal and/or business investment strategies. Execution then returns back to step 64 for the identification of a subsequent customer that is to be introduced to the software application at step 66 and provided an opportunity to purchase the software application.

Thus, as discussed herein, the embodiments of the present invention embrace systems and methods for creating and distributing a software application. More particular, the present invention relates to creating a software application that includes a category for sweeping or transferring information, such as financial information, to one or more products provided by a particular professional, and utilizing the professional to distribute the software application to end users.

The creation of a software application that includes categories that sweep information to products is advantageous to the user. For example, the where the application is a financial management tool, the software application assists the user in controlling finances and in identifying incremental discretionary income that may be used to purchase investment and/or insurance products. Furthermore, the use of the professional as a distribution channel for the software application utilizes pre-established relationships of trust between the professional and established customers, creates more opportunities for first-time sales of the software application, provides more interaction for the professional with the customers in order to more frequently discuss products and/or services, establishes a credible endorsement for the software application, and/or provides ongoing follow-up and support to the client for the application purchased. Moreover, in accordance with the present invention, professionals are able to kindle a customer relationship outside of their traditional business to facilitate or otherwise provide a broader scope of products.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A method for distributing a software application for use in association with a computer device, the method comprising the steps for:
providing a software application, wherein the software application includes a category corresponding to a product; and
engaging a professional to market the software application to a customer, wherein the professional provides the product to the customer.

2. A method as recited in claim 1, wherein the category initiates a transfer of information corresponding to the product.

3. A method as recited in claim 2, wherein the information is financial information.

4. A method as recited in claim 3, wherein the software application manages financial information, and wherein the transfer is initiated by identifying an amount of income that is to be transferred to the product.

5. A method as recited in claim 4, wherein the transfer of information is:
(i.) automatically performed; or
(ii.) selectively performed.

6. A method as recited in claim 4, wherein the product includes one of:
(i.) an insurance policy;
(ii.) a savings plan; or
(iii.) an investment account.

7. A method as recited in claim 4, wherein the professional is one of:
(i.) an insurance agent;
(ii.) a financial planner;
(iii.) a tax preparer;
(iv.) a representative of a bank;
(v.) a representative of a credit union;
(vi.) a stock broker; or
(vii.) an accountant.

8. A method as recited in claim 7, wherein the professional markets the software application by performing the steps for:
identifying the customer; and
introducing the customer to the software application.

9. A method as recited in claim 8, wherein if the customer purchases the software application, the professional provides assistance relating to the software application to the customer.

10. A method as recited in claim 9, wherein if the customer purchases the software application, the professional receives a commission on at least one of:
(i.) a sale of the software application; and
(ii.) ensuing service fees.

11. A method as recited in claim 1, wherein the computer device is one of;
(i.) a personal computer;
(ii.) a notebook computer;
(iii.) a hand-held device;
(iv.) a minicomputer;
(v.) a multi-processor system;
(vi.) a network computer; or
(vii.) a processor-based consumer electronic device.

12. A distribution channel of a software application to a user, wherein the software application is configured for use in association with a computer device, the channel comprising:
a product; and
a professional engaged in the business of providing the product to a first customer, wherein the professional is further engaged in marketing the software application to a second customer, and wherein the software application is configured to transfer information corresponding to the product.

13. A distribution channel as recited in claim 12, wherein the information transferred is financial information.

14. A distribution channel as recited in claim 13, wherein the professional is one of:
(i.) an insurance agent;
(ii.) a financial planner;
(iii.) a tax preparer;
(iv.) a representative of a bank;
(v.) a representative of a credit union;
(vi.) a stock broker; or
(vii.) an accountant.

15. A distribution channel as recited in claim 13, wherein the product is one of:
(i.) an insurance policy;
(ii.) a savings plan; or
(iii.) an investment account.

16. A distribution channel as recited in claim 12, wherein the second customer is the first customer.

17. A computer program product for implementing within a computer system a method for transferring information corresponding to a product available through a professional, the computer program product comprising:
computer readable medium for providing computer program code means utilized to implement the method, wherein the computer program code means is comprised of executable code for implementing the steps for:
providing a category corresponding to the product;
tracking information; and
identifying information to transfer, wherein the information is identified from the tracked information, and wherein the identified information corresponds to the category and to the product.

18. A computer program product as recited in claim 17, wherein the computer program code means is further comprised of executable code for implementing the steps for:
defining a period of time for performing the step for tracking information; and
transferring the identified information.

19. A computer program product as recited in claim 17, wherein the information tracked is financial information.

20. A computer program product as recited in claim 19, wherein the identified information represents an amount for transfer to the product.

21. A computer program product as recited in claim 20, wherein the product is one of:
(i.) an insurance policy;
(ii.) a savings plan; or
(iii.) an investment account.
